(19) United States
(12) Patent Application Publication
(10) Pub. No.: US 2022/0203989 A1
(43) Pub. Date: Jun. 30, 2022

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Tomoyuki Hosoya, Wako-shi (JP); Yasuharu Hashimoto, Wako-shi (JP); Hirofumi Kanazaki, Wako-shi (JP)

(21) Appl. No.: 17/557,084

(22) Filed: Dec. 21, 2021

(30) Foreign Application Priority Data
Dec. 28, 2020 (JP) 2020-218529

(51) Int. Cl. B60W 30/18; B60W 10/04; B60W 10/20

(52) U.S. Cl. CPC B60W 30/18145; B60W 10/04; B60W 10/20; B60W 2520/10; B60W 2710/18; B60W 2552/30; B60W 2710/20; B60W 2720/125; B60W 2720/106; B60W 2520/12

(57) ABSTRACT

A vehicle control device includes a recognition unit configured to recognize a position and a surrounding situation of a vehicle, a driving control unit configured to control steering and acceleration/deceleration of the vehicle independently of an operation of a driver of the vehicle, and a mode determination unit configured to determine any one of a plurality of driving modes including a first driving mode and a second driving mode as a driving mode of the vehicle and change the driving mode of the vehicle to a driving mode in which a task is severer when a task associated with the determined driving mode is not executed by the driver, the second driving mode being a driving mode in which a task imposed on the driver is milder than that in the first driving mode. When accuracy of recognition of the position of the vehicle is lowered, the mode determination unit estimates a speed at which the vehicle travels on a road on the basis of curvature of the road in front of the vehicle and changes the driving mode of the vehicle when the estimated speed exceeds a predetermined prescribed speed.

### CROSS-REFERENCE TO RELATED APPLICATION

Priority is claimed on Japanese Patent Application No. 2020-218529, filed Dec. 28, 2020, the content of which is incorporated herein by reference.

### BACKGROUND OF THE INVENTION

### Field of the Invention

The present invention relates to a vehicle control device, a vehicle control method, and a storage medium.

### Description of Related Art

In the related art, the invention of an in-vehicle system including: a storage determination processing unit configured to iteratively determine the presence or absence of highly accurate map information with respect to a road on which a host vehicle travels; a storage information acquisition processing unit configured to acquire information indicating iterated determination results; and an automated driving propriety notification unit configured to provide a notification of the information acquired by the storage information acquisition processing unit has been disclosed (see, for example, Japanese Unexamined Patent Application, First Publication No. 2018-189594).

### SUMMARY OF THE INVENTION

Although information stored in a map is used to provide an automated driving propriety notification mechanically in the conventional technology, the actual traffic situation is more complicated and it may be difficult to perform appropriate control according to a road structure.

Aspects according to the present invention have been made in consideration of such circumstances and an objective of the present invention is to provide a vehicle control device, a vehicle control method, and a storage medium capable of performing appropriate control according to a road structure.

To achieve the objective by solving the above-mentioned problem, the present invention adopts the following aspects.

(1): According to an aspect of the present invention, there is provided a vehicle control device including: a recognition unit configured to recognize a position and a surrounding situation of a vehicle; a driving control unit configured to control steering and acceleration/deceleration of the vehicle independently of an operation of a driver of the vehicle; and a mode determination unit configured to determine any one of a plurality of driving modes including a first driving mode and a second driving mode as a driving mode of the vehicle and change the driving mode of the vehicle to a driving mode in which a task is severer when a task associated with the determined driving mode is not executed by the driver, the second driving mode being a driving mode in which a task imposed on the driver is milder than that in the first driving mode, some of the plurality of driving modes including at least the second driving mode being controlled by the driving control unit, wherein, when accuracy of recognition of the position of the vehicle is lowered, the mode determination unit estimates a speed at which the vehicle travels on a road on the basis of curvature of the road in front of the vehicle and changes the driving mode of the vehicle from the second driving mode to the first driving mode when the estimated speed exceeds a predetermined prescribed speed.

(2): In the above-described aspect (1), the second driving mode may be a driving mode in which a task of gripping an operation element for receiving a steering operation is not imposed on the driver, and the first driving mode may be a driving mode in which a driving operation by the driver is required in relation to at least one of the steering and the acceleration/deceleration of the vehicle.

(3): In the above-described aspect (1), the second driving mode may be a driving mode in which a task of gripping an operation element for receiving a steering operation is not imposed on the driver, and the first driving mode may be a driving mode in which at least the task of gripping the operation element for receiving the steering operation by the driver is imposed on the driver.

(4): In any one of the above-described aspects (1) to (3), the prescribed speed may be a speed less than or equal to an upper limit of a speed at which the vehicle is able to travel in a traveling lane on the road having the curvature.

(5): According to an aspect of the present invention, there is provided a vehicle control method including: recognizing, by a computer mounted in a vehicle, a surrounding situation of the vehicle; controlling, by the computer, steering and acceleration/deceleration of the vehicle independently of an operation of a driver of the vehicle; determining, by the computer, any one of a plurality of driving modes including a first driving mode and a second driving mode as a driving mode of the vehicle, the second driving mode being a driving mode in which a task imposed on the driver is milder than that in the first driving mode, some of the plurality of driving modes including at least the second driving mode being performed by controlling the steering and the acceleration/deceleration of the vehicle independently of the operation of the driver of the vehicle; changing, by the computer, the driving mode of the vehicle to a driving mode in which a task is severer when a task associated with the determined driving mode is not executed by the driver; estimating, by the computer, a speed at which the vehicle travels on a road on the basis of curvature of the road in front of the vehicle when accuracy of recognition of the position of the vehicle is lowered; and changing, by the computer, the driving mode of the vehicle from the second driving mode to the first driving mode when the estimated speed exceeds a predetermined prescribed speed.

(6): According to an aspect of the present invention, there is provided a computer-readable non-transitory storage medium storing a program for causing a computer mounted in a vehicle to: recognize a surrounding situation of the vehicle; control steering and acceleration/deceleration of the vehicle independently of an operation of a driver of the vehicle; determine any one of a plurality of driving modes including a first driving mode and a second driving mode as a driving mode of the vehicle, the second driving mode being a driving mode in which a task imposed on the driver is milder than that in the first driving mode, some of the plurality of driving modes including at least the second driving mode being performed by controlling the steering and the acceleration/deceleration of the vehicle independently of the operation of the driver of the vehicle; change the driving mode of the vehicle to a driving mode in which a task is severer when a task associated with the determined driving mode is not executed by the driver; estimate a speed at which the vehicle travels on a road on the basis of curvature of the road in front of the vehicle when accuracy of recognition of the position of the vehicle is lowered; and change the driving mode of the vehicle from the second driving mode to the first driving mode when the estimated speed exceeds a predetermined prescribed speed.

According to the above-described aspects (1) to (6), it is possible to perform appropriate control according to a road structure.

### BRIEF DESCRIPTION OF THE DRAWINGS

FIG. 1 is a configuration diagram of a vehicle system using a vehicle control device according to an embodiment.

FIG. 2 is a functional configuration diagram of a first control unit and a second control unit.

FIG. 3 is a diagram showing an example of corresponding relationships between a driving mode, a control state of a host vehicle, and a task.

FIG. 4 is a diagram showing an example of a corresponding relationship between a turning radius and a dead reckoning limit speed.

FIG. 5 is a flowchart showing an example of a flow of a driving mode change process of a mode determination unit in an automated driving control device.

FIG. 6 is a diagram for describing an outline of the driving mode change process.

### DETAILED DESCRIPTION OF THE INVENTION

Hereinafter, embodiments of a vehicle control device, a vehicle control method, and a storage medium of the present invention will be described with reference to the drawings.

### Overall Configuration

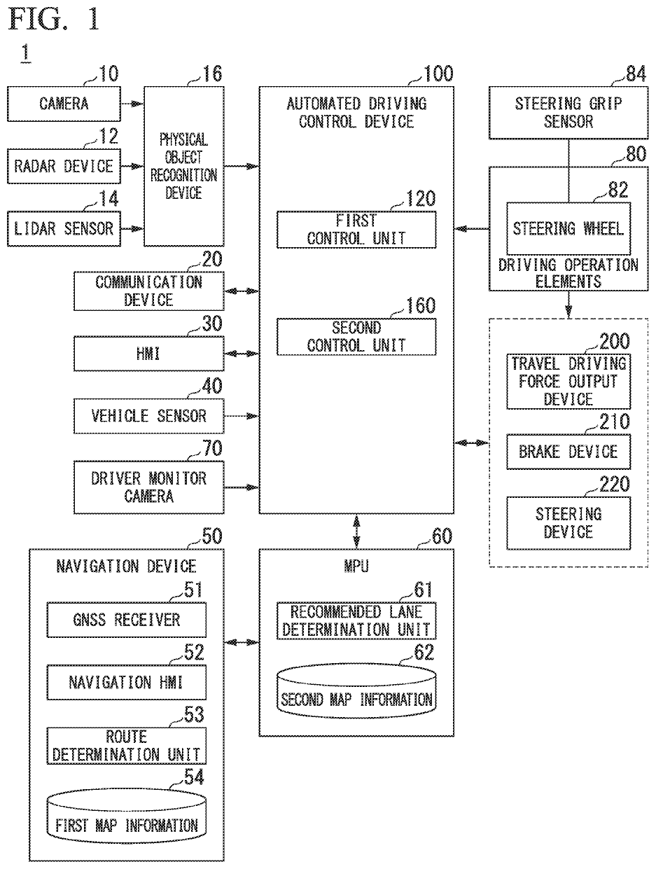

FIG. 1 is a configuration diagram of a vehicle system 1 using a vehicle control device. A vehicle equipped with the vehicle system 1 is, for example, a vehicle such as a two-wheeled vehicle, a three-wheeled vehicle, or a four-wheeled vehicle. A driving source of these vehicles is an internal combustion engine such as a diesel engine or a gasoline engine, an electric motor, or a combination thereof. The electric motor operates using electric power generated by a power generator connected to the internal combustion engine, or discharge power of a secondary battery or a fuel cell.

For example, the vehicle system 1 includes a camera 10, a radar device 12, a light detection and ranging (LIDAR) sensor 14, a physical object recognition device 16, a communication device 20, a human machine interface (HMI) 30, a vehicle sensor 40, a navigation device 50, a map positioning unit (MPU) 60, a driver monitor camera 70, driving operation elements 80, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and some of the components may be omitted or other components may be further added.

For example, the camera 10 is a digital camera using a solid-state imaging element such as a charge coupled device (CCD) or a complementary metal oxide semiconductor (CMOS). The camera 10 is attached to any position on the vehicle (hereinafter, a host vehicle M) in which the vehicle system 1 is mounted. When the view in front of the host vehicle M is imaged, the camera 10 is attached to an upper part of a front windshield, a rear surface of a rearview mirror, or the like. For example, the camera 10 periodically and iteratively images the surroundings of the host vehicle M. The camera 10 may be a stereo camera.

The radar device 12 radiates radio waves such as millimeter waves around the host vehicle M and detects at least a position (a distance to and a direction) of a physical object by detecting radio waves (reflected waves) reflected by the physical object. The radar device 12 is attached to any position on the host vehicle M. The radar device 12 may detect a position and a speed of the physical object in a frequency modulated continuous wave (FM-CW) scheme.

The LIDAR sensor 14 radiates light (or electromagnetic waves of a wavelength close to an optical wavelength) to the vicinity of the host vehicle M and measures scattered light. The LIDAR sensor 14 detects a distance to an object on the basis of a time period from light emission to light reception. The radiated light is, for example, pulsed laser light. The LIDAR sensor 14 is attached to any position on the host vehicle M.

The physical object recognition device 16 performs a sensor fusion process on detection results from some or all of the camera 10, the radar device 12, and the LIDAR sensor 14 to recognize a position, a type, a speed, and the like of a physical object. The physical object recognition device 16 outputs recognition results to the automated driving control device 100. The physical object recognition device 16 may output detection results of the camera 10, the radar device 12, and the LIDAR sensor 14 to the automated driving control device 100 as they are. The physical object recognition device 16 may be omitted from the vehicle system 1.

The communication device 20 communicates with another vehicle in the vicinity of the host vehicle M using, for example, a cellular network, a Wi-Fi network, Bluetooth (registered trademark), dedicated short range communication (DSRC), or the like, or communicates with various types of server devices via a radio base station.

The HMI 30 provides an occupant of the host vehicle M with various types of information and receives an input operation by the occupant. The HMI 30 includes various types of display devices, a speaker, a buzzer, a touch panel, a switch, a key, and the like.

The vehicle sensor 40 includes a vehicle speed sensor configured to detect the speed of the host vehicle M, an acceleration sensor configured to detect acceleration, a yaw rate sensor configured to detect an angular speed around a vertical axis, a direction sensor configured to detect a direction of the host vehicle M, and the like.

For example, the navigation device 50 includes a global navigation satellite system (GNSS) receiver 51, a navigation HMI 52, and a route determination unit 53. The navigation device 50 stores first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determination unit 53 determines a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include curvature of a road, point of interest (POI) information, and the like. The route on the map is output to the MPU 60. The navigation device 50 may perform route guidance using the navigation HMI 52 based on the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

For example, the MPU 60 includes a recommended lane determination unit 61 and stores second map information 62 in a storage device such as an HDD or a flash memory. The recommended lane determination unit 61 divides the route on the map provided from the navigation device 50 into a plurality of blocks (for example, divides the route every 100 [m] in a traveling direction of the vehicle), and determines a recommended lane for each block with reference to the second map information 62. The recommended lane determination unit 61 determines what number lane the vehicle travels in from the left. The recommended lane determination unit 61 determines the recommended lane so that the host vehicle M can travel along a reasonable route for traveling to a branching destination when there is a branch point in the route on the map.

The second map information 62 is map information which has higher accuracy than the first map information 54. For example, the second map information 62 includes information about a center of a lane, information about a boundary of a lane, and the like. The second map information 62 may include road information, traffic regulations information, address information (an address/postal code), facility information, telephone number information, and the like. The second map information 62 may be updated at any time when the communication device 20 communicates with another device.

The driver monitor camera 70 is, for example, a digital camera that uses a solid-state image sensor such as a CCD or a CMOS. The driver monitor camera 70 is attached to any position on the host vehicle M at a position in a direction in which the head of an occupant (hereinafter referred to as a driver) seated in the driver's seat of the host vehicle M can be imaged from the front (in a direction in which his/her face is imaged), and is arbitrary in the host vehicle M. For example, the driver monitor camera 70 is attached to an upper part of a display device provided on the central portion of an instrument panel of the host vehicle M.

The driving operation elements 80 include, for example, an accelerator pedal, a brake pedal, a shift lever, and other operation elements in addition to the steering wheel 82. A sensor for detecting an amount of operation or the presence or absence of an operation is attached to the driving operation element 80 and a detection result is output to the automated driving control device 100 or some or all of the travel driving force output device 200, the brake device 210, and the steering device 220. The steering wheel 82 is an example of an “operation element for receiving a steering operation by the driver.” The operation element does not necessarily have to be annular and may be in the form of a variant steering wheel, a joystick, a button, or the like. A steering grip sensor 84 is attached to the steering wheel 82. The steering grip sensor 84 is implemented by a capacitance sensor or the like, and automatically transmits a signal for detecting whether or not the driver is gripping the steering wheel 82 (indicating that the driver is in contact with the steering wheel 82 in a state in which a force is applied) to the automated driving control device 100.

The automated driving control device 100 includes, for example, a first control unit 120 and a second control unit 160. Each of the first control unit 120 and the second control unit 160 is implemented, for example, by a hardware processor such as a central processing unit (CPU) executing a program (software). Some or all of the above components may be implemented by hardware (including a circuit; circuitry) such as a large-scale integration (LSI) circuit, an application specific integrated circuit (ASIC), a field-programmable gate array (FPGA), or a graphics processing unit (GPU) or may be implemented by software and hardware in cooperation. The program may be prestored in a storage device (a storage device including a non-transitory storage medium) such as an HDD or a flash memory of the automated driving control device 100 or may be stored in a removable storage medium such as a DVD or a CD-ROM and installed in the HDD or the flash memory of the automated driving control device 100 when the storage medium (the non-transitory storage medium) is mounted in a drive device. The automated driving control device 100 is an example of a “vehicle control device.” A combination of the action plan generation unit 140 and the second control unit 160 is an example of a “driving control unit.”

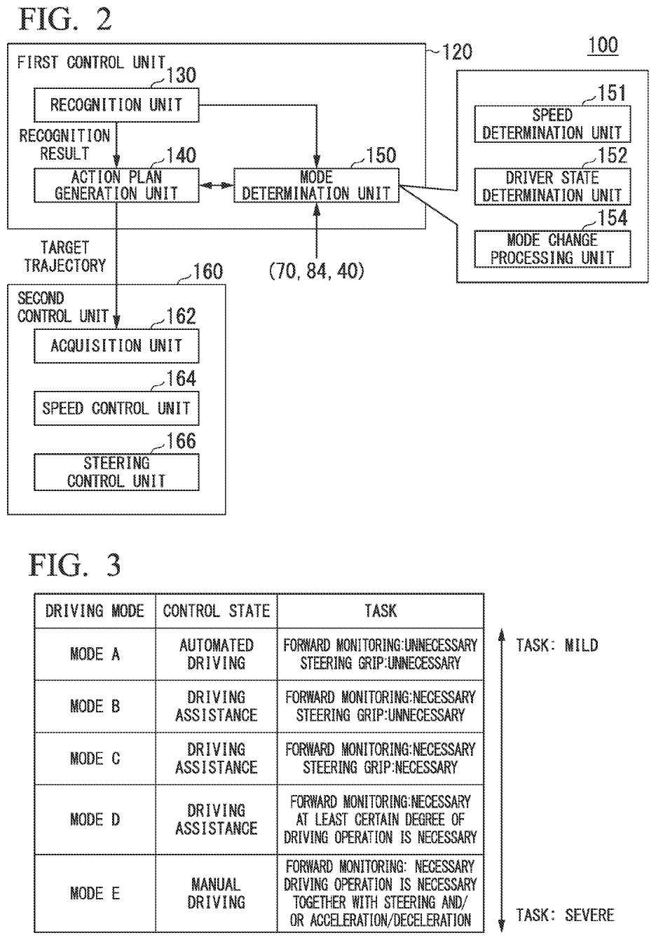

FIG. 2 is a functional configuration diagram of the first control unit 120 and the second control unit 160. The first control unit 120 includes, for example, a recognition unit 130, the action plan generation unit 140, and a mode determination unit 150. For example, the first control unit 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both the recognitions. Thereby, the reliability of automated driving is secured.

The recognition unit 130 recognizes states of positions, speeds, acceleration, and the like of physical objects near the host vehicle M on the basis of information input from the camera 10, the radar device 12, and the LIDAR sensor 14 via the physical object recognition device 16. For example, the position of the physical object is recognized as a position on absolute coordinates with a representative point (a center of gravity, a driving shaft center, or the like) of the host vehicle M as the origin and is used for control. The position of the physical object may be represented by a representative point such as a center of gravity or a corner of the physical object or may be represented by a represented area. The “state” of a physical object may include acceleration or jerk of the physical object or an “action state” (for example, whether or not a lane change is being made or intended).

For example, the recognition unit 130 recognizes a lane in which the host vehicle M is traveling (a traveling lane). For example, the recognition unit 130 recognizes the traveling lane by comparing a pattern of a road marking line (for example, an arrangement of solid lines and broken lines) obtained from the second map information 62 with a pattern of road marking lines in the vicinity of the host vehicle M recognized from an image captured by the camera 10. The recognition unit 130 may recognize the traveling lane by recognizing a traveling path boundary (a road boundary) including a road marking line, a road shoulder, a curb stone, a median strip, a guardrail, or the like as well as a road marking line. In this recognition, a position of the host vehicle M acquired from the navigation device 50 or a processing result of the INS may be added. The recognition unit 130 may recognize a temporary stop line, an obstacle, red traffic light, a toll gate, and other road events.

When the traveling lane is recognized, the recognition unit 130 recognizes a relative position or orientation of the host vehicle M with respect to the traveling lane. For example, the recognition unit 130 may recognize a gap of a reference point of the host vehicle M from the center of the lane and an angle formed with respect to a line connected to the center of the lane in a traveling direction of the host vehicle M as a relative position and orientation of the host vehicle M related to the traveling lane. Alternatively, the recognition unit 130 may recognize a position of the reference point of the host vehicle M related to one side end portion (a road marking line or a road boundary) of the traveling lane or the like as a relative position of the host vehicle M related to the traveling lane.

Here, the recognition unit 130 can basically use highly accurate position information acquired by the GNSS receiver 51 of the navigation device 50 in the recognition of the position of the host vehicle M. The recognition unit 130 can recognize a surrounding situation of the host vehicle M with high accuracy using highly accurate position information and highly accurate map information (for example, the first map information 54 or the second map information 62). However, during traveling underground or in a tunnel, the reception of position information by the GNSS receiver 51 may be interrupted or unstable, and in such a situation, it becomes difficult to recognize the position of the host vehicle M. Also, if road marking lines cannot be recognized for some reason, it becomes difficult to recognize the position of the host vehicle M. Therefore, in the automated driving control device 100 of the present embodiment, the recognition unit 130 has a function of recognizing the position of the host vehicle M according to dead reckoning so that the position recognition of the host vehicle M can be continued even in such an abnormal situation. The dead reckoning is technology for enabling highly accurate position measurement even in situations where position measurement by a GNSS alone is difficult by performing an arithmetic process in conjunction with information from various types of sensors such as a gyro sensor and an acceleration sensor. By having such a function, the recognition unit 130 can continue the recognition of the position of the host vehicle M even in the above-mentioned abnormal situation.

However, because the accuracy of position recognition by the dead reckoning is lower than the accuracy of position recognition by highly accurate position information acquired by the GNSS receiver 51, there is a possibility that the accuracy of control of the automated driving of the host vehicle M will decrease in the situation where position recognition is performed according to the dead reckoning. Hereinafter, the situation in which the host vehicle M is traveling while performing the dead reckoning is referred to as a dead reckoning state. Specifically, when the accuracy of position recognition decreases, a deviation may occur between the actual traveling position of the host vehicle M and the position recognized by the automated driving control device 100 and a situation in which the traveling speed of the host vehicle M is not suitable for a situation on the road on which the host vehicle M is traveling actually may occur. Therefore, in the automated driving control device 100 of the present embodiment, the mode determination unit 150, which will be described below, lowers an automated driving level or the vehicle speed, so that unstable traveling of the vehicle is limited when the host vehicle M is traveling on a curved road.

The action plan generation unit 140 generates a future target trajectory along which the host vehicle M automatedly travels (independently of the driver's operation) so that the host vehicle M can generally travel in the recommended lane determined by the recommended lane determination unit 61 and cope with a surrounding situation of the host vehicle M. For example, the target trajectory includes a speed element. For example, the target trajectory is represented by sequentially arranging points (trajectory points) at which the host vehicle M is required to arrive. The trajectory points are points at which the host vehicle M is required to arrive for each prescribed traveling distance (for example, about several meters [m]) along a road. In addition, a target speed and target acceleration for each prescribed sampling time (for example, about several tenths of a second [sec]) are generated as parts of the target trajectory. The trajectory point may be a position at which the host vehicle M is required to arrive at the sampling time for each prescribed sampling time. In this case, information about the target speed or the target acceleration is represented by an interval between the trajectory points.

The action plan generation unit 140 may set an automated driving event when a target trajectory is generated. Automated driving events include a constant-speed traveling event, a low-speed tracking event, a lane change event, a branch-point-related movement event, a merge-point-related movement event, a takeover event, and the like. The action plan generation unit 140 generates a target trajectory according to an activated event.

The mode determination unit 150 determines any one of a plurality of driving modes in which tasks imposed on the driver are different as the driving mode of the host vehicle M. The mode determination unit 150 includes, for example, a speed determination unit 151, a driver state determination unit 152, and a mode change processing unit 154. These individual functions will be described below.

FIG. 3 is a diagram showing an example of corresponding relationships between the driving mode, the control state of the host vehicle M, and the task. The driving modes of the host vehicle M include, for example, five modes from mode A to mode E. A degree of automation of the control state, i.e., the driving control of the host vehicle M, is highest in mode A, decreases in the order of mode B, mode C, and mode D, and is lowest in mode E. In contrast, the task imposed on the driver is mildest in mode A, becomes severer in the order of mode B, mode C, and mode D, and is severest in mode E. In modes D and E, the control state is not automated driving, so the automated driving control device 100 is responsible for ending the control related to automated driving and performing the shift to driving assistance or manual driving. Hereinafter, content of each driving mode will be exemplified.

In mode A, the state is an automated driving state and neither forward monitoring nor gripping of the steering wheel 82 (steering gripping in FIG. 3) is imposed on the driver. However, even in mode A, the driver is required to be in a posture where the fast shift to manual driving is enabled in response to a request from the system centered on the automated driving control device 100. The term “automated driving” as used herein indicates that both steering and acceleration/deceleration are controlled independently of the operation of the driver. The term “forward or front” indicates a space in a traveling direction of the host vehicle M that is visually recognized through the front windshield. Mode A is a driving mode in which the host vehicle M travels at a prescribed speed (for example, about 50 [km/h]) or less on a motorway such as an expressway and which can be executed when a condition in which there is a tracking target preceding vehicle or the like is satisfied. Mode A may be referred to as a traffic jam pilot (TJP). When this condition is no longer satisfied, the mode determination unit 150 changes the driving mode of the host vehicle M to mode B.

In mode B, the state is a driving assistance state and a task of monitoring an area in front of the host vehicle M (hereinafter referred to as forward monitoring) is imposed on the driver, but a task of gripping the steering wheel 82 is not imposed on the driver. In mode C, the state is a driving assistance state and a forward monitoring task and a task of gripping the steering wheel 82 are imposed on the driver. Mode D is a driving mode in which a certain degree of driving operation by the driver is required for at least one of steering and acceleration/deceleration of the host vehicle M. For example, in mode D, driving assistance such as adaptive cruise control (ACC) or lane keeping assist system (LKAS) is provided. In mode E, both steering and acceleration/deceleration are in a state of manual driving that requires a driving operation by the driver. In both mode D and mode E, a task of monitoring an area in front of the host vehicle M is naturally imposed on the driver.

The automated driving control device 100 (and a driving assistance device (not shown)) executes an automated lane change according to the driving mode. Automated lane changes include an automated lane change (1) due to a system request and an automated lane change (2) due to a driver request. The automated lane change (1) is an automated lane change for overtaking and an automated lane change for traveling toward a destination (an automated lane change based on a change in a recommended lane) performed when the speed of the preceding vehicle is at least a reference level less than the speed of the host vehicle. In the automated lane change (2), if a condition related to a speed, a positional relationship with a nearby vehicle, or the like is satisfied, the host vehicle M is allowed to change the lane in an operation direction when a direction indicator has been operated by the driver.

The automated driving control device 100 does not execute either the automated lane change (1) or (2) in mode A. The automated driving control device 100 executes both the automated lane changes (1) and (2) in modes B and C. The driving assistance device (not shown) does not execute the automated lane change (1) but executes the automated lane change (2) in mode D. In mode E, neither the automated lane change (1) nor (2) is executed.

The mode determination unit 150 changes the driving mode of the host vehicle M to a driving mode in which the task is severer when the task associated with the determined driving mode (hereinafter, the present driving mode) is not executed by the driver.

For example, in mode A, when the driver is in a posture where he/she cannot shift the driving to manual driving in response to a request from the system (for example, when he/she continues to look outside an allowable area or when a sign that driving becomes difficult is detected), the mode determination unit 150 performs control for prompting the driver to shift the driving to manual driving using the HMI 30, causing the host vehicle M to be gradually stopped close to the road shoulder when the driver does not respond, and stopping the automated driving. After the automated driving is stopped, the host vehicle is in mode D or E and the host vehicle M can be started according to the manual driving of the driver. Hereinafter, the same is true for “stopping of automated driving.” When the driver is not performing forward monitoring in mode B, the mode determination unit 150 performs control for prompting the driver to perform forward monitoring using the HMI 30, causing the host vehicle M to be gradually stopped close to the road shoulder when the driver does not respond, and stopping the automated driving. When the driver is not performing forward monitoring in mode C or is not gripping the steering wheel 82, the mode determination unit 150 performs control for prompting the driver to perform the forward monitoring and/or grip the steering wheel 82 using the HMI 30, causing the host vehicle M to be gradually stopped close to the road shoulder when the driver does not respond, and stopping the automated driving.

For example, when the host vehicle M is expected not to maintain the lane in which the vehicle M is traveling in modes A to D, the mode determination unit 150 requests the driver to shift the driving to the manual driving using the HMI 30. Here, when the driver responds to the request for shifting to the manual driving, the mode determination unit 150 performs control for changing the driving mode to mode E. Alternatively, in this case, the mode determination unit 150 may perform control for changing the present driving mode to a driving mode in which a severer task is imposed on the driver. For example, when the present driving mode is mode A or B, the mode determination unit 150 may perform control for changing the driving mode to mode C or D. On the other hand, if the driver does not respond to the request for shifting to the manual driving, the mode determination unit 150 performs control for causing the host vehicle M to be gradually stopped close to the road shoulder and stopping the automated driving.

For example, when the host vehicle M is expected not to maintain the lane in which the host vehicle M is traveling in modes A to D, the mode determination unit 150 may perform control for maintaining the present driving mode and decelerating the host vehicle M so that the lane can be maintained while the host vehicle M is traveling.

The speed determination unit 151 predicts a traveling speed of the host vehicle M after the elapse of a prescribed time period for the above mode change and determines whether or not the predicted traveling speed is within an allowable range for maintaining the traveling lane. The speed determination unit 151 determines to maintain the present driving mode if the predicted traveling speed is within the allowable range and determines to change the present driving mode if the predicted running speed is not within the allowable range. The speed determination unit 151 notifies the mode change processing unit 154 of a determination result.

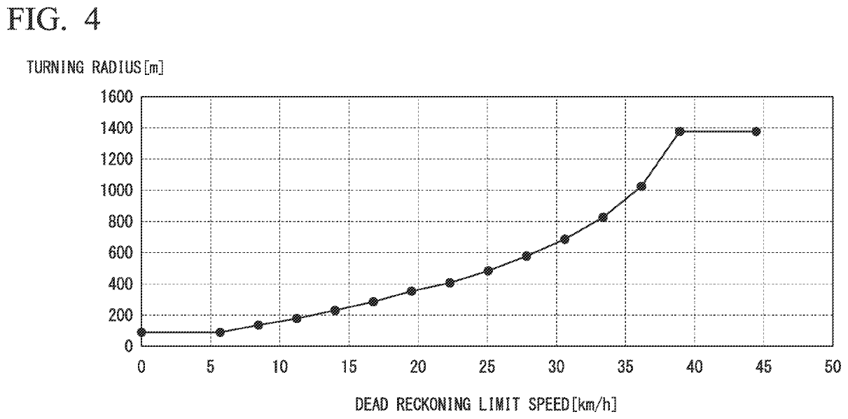

Here, the allowable range of the traveling speed is represented by a corresponding relationship between a turning radius (a curvature radius) of a curved road on which the host vehicle M travels according to automated driving (including driving assistance) based on a result of position recognition by the dead reckoning and a speed limit (hereinafter referred to as a “dead reckoning limit speed”) at which the automated driving of the host vehicle M can be controlled so that the host vehicle M traveling on a curved road maintains a traveling lane. FIG. 4 is a diagram showing an example of a corresponding relationship between the turning radius and the dead reckoning limit speed. Hereinafter, information indicating the corresponding relationship between the turning radius and the dead reckoning limit speed is referred to as “corresponding information”. It is assumed that the corresponding information is prestored in the storage unit of the automated driving control device 100.

For example, in the example of FIG. 4, a case in which, when the host vehicle M is allowed to travel on a curved road having a turning radius of 690 m according to the automated driving, an upper limit of the traveling speed at which the host vehicle M can be controlled so that the host vehicle M travels while maintaining a traveling lane (i.e., the dead reckoning limit speed) is 30.6 km/h is shown. Generally, a theoretical value of the speed at which a vehicle can travel on a curved road while maintaining a traveling lane is obtained from a relationship between the turning radius of the curved road and the traveling speed of the vehicle, but it is only necessary for the dead reckoning limit speed according to the present embodiment to be determined in consideration of an influence of a decrease in the accuracy of position recognition by the dead reckoning on the control accuracy of automated driving, an influence of deceleration of the host vehicle M on the traveling of nearby vehicles, and the like on the basis of the above theoretical value.

The driver state determination unit 152 monitors the driver's state for the above mode change and determines whether or not the driver's state is a state according to the task. For example, the driver state determination unit 152 analyzes an image captured by the driver monitor camera 70 to perform an orientation estimation process and determines whether or not the driver is in a posture where he/she cannot shift the driving to manual driving in response to a request from the system. The driver state determination unit 152 analyzes an image captured by the driver monitor camera 70 to perform a line-of-sight estimation process and determines whether or not the driver is performing forward monitoring.

The mode change processing unit 154 performs various types of processes for changing the mode when the speed determination unit 151 determines to change the driving mode. For example, the mode change processing unit 154 instructs the action plan generation unit 140 to generate a target trajectory for stopping the vehicle at the road shoulder, gives an operation instruction to a driving assistance device (not shown), or controls the HMI 30 so that the driver is prompted to take an action.

The second control unit 160 controls the travel driving force output device 200, the brake device 210, and the steering device 220 so that the host vehicle M passes along the target trajectory generated by the action plan generation unit 140 at the scheduled times.

Returning to FIG. 2, the second control unit 160 includes, for example, an acquisition unit 162, a speed control unit 164, and a steering control unit 166. The acquisition unit 162 acquires information of a target trajectory (trajectory points) generated by the action plan generation unit 140 and causes a memory (not shown) to store the information. The speed control unit 164 controls the travel driving force output device 200 or the brake device 210 on the basis of a speed element associated with the target trajectory stored in the memory. The steering control unit 166 controls the steering device 220 in accordance with a degree of bending of the target trajectory stored in the memory. The processes of the speed control unit 164 and the steering control unit 166 are implemented by, for example, a combination of feedforward control and feedback control. As an example, the steering control unit 166 executes a combination of feedforward control according to the curvature of the road in front of the host vehicle M and feedback control based on a deviation from the target trajectory.

The travel driving force output device 200 outputs a travel driving force (torque) for enabling the vehicle to travel to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described components in accordance with information input from the second control unit 160 or information input from the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second control unit 160 or the information input from the driving operation element 80 so that brake torque according to a braking operation is output to each wheel. The brake device 210 may include a mechanism configured to transfer the hydraulic pressure generated by an operation of the brake pedal included in the driving operation elements 80 to the cylinder via a master cylinder as a backup. The brake device 210 is not limited to the above-described configuration and may be an electronically controlled hydraulic brake device configured to control an actuator in accordance with information input from the second control unit 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the second control unit 160 or the information input from the driving operation element 80 to change the direction of the steerable wheels.

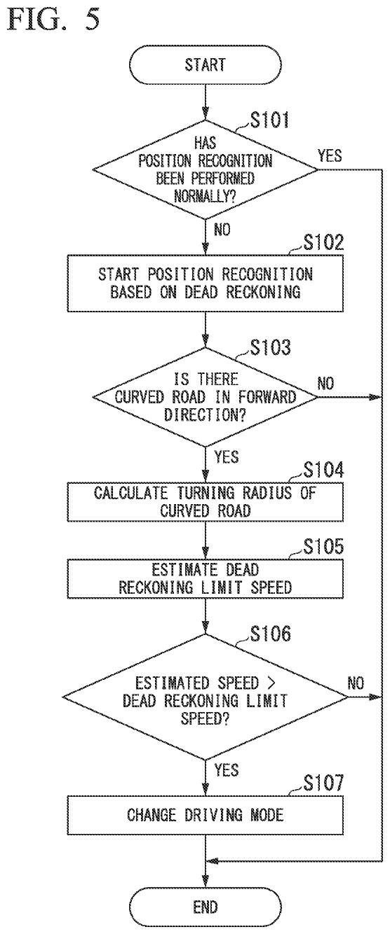

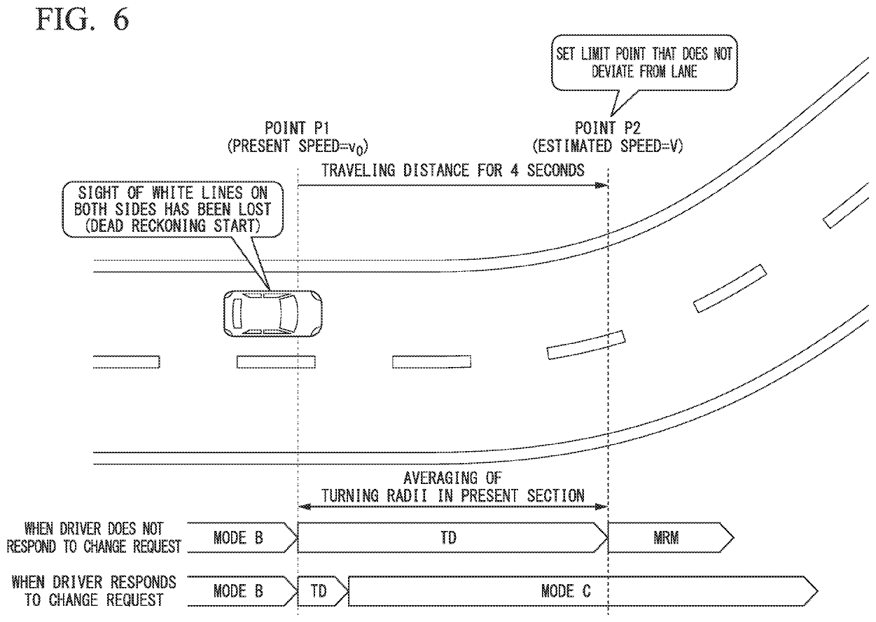

FIG. 5 is a flowchart showing an example of a flow of a driving mode change process of the mode determination unit 150 of the automated driving control device 100. FIG. 6 is a diagram for describing an outline of the driving mode change process. Hereinafter, the flow of the driving mode change process shown in FIG. 5 will be described with reference to FIG. 6 as appropriate. For the sake of simplicity, the flow of the driving mode change process in one cycle of the iterative process is shown in FIG. 6, but the entire driving mode change process is implemented by iteratively executing a series of processing steps shown in FIG. 6 at prescribed timings in reality.

First, the recognition unit 130 determines whether or not the position recognition of the host vehicle M has been performed normally (step S101). Here, when it is determined that the position recognition of the host vehicle M has not been performed normally, the recognition unit 130 starts the position recognition of the host vehicle M by dead reckoning (step S102). In this case, with the start of the dead reckoning, the mode determination unit 150 determines whether or not there is a curved road at a prescribed distance from the host vehicle M in a forward direction (step S103). Here, when it is determined that there is a curved road at the prescribed distance from the host vehicle M in the forward direction, the mode determination unit 150 calculates a turning radius of the curved road in front of the host vehicle M (step S104).

For example, FIG. 6 shows an example in which the recognition unit 130 loses sight of a road marking line at a timing when the host vehicle M has reached a present traveling point P1 and the position recognition by the dead reckoning is started with the loss of sight as a trigger. In this case, for example, the recognition unit 130 estimates a traveling position of the host vehicle M after the elapse of a prescribed time period and determines whether or not a road on which the host vehicle M travels after the elapse of the prescribed time period is a curved road on the basis of the estimated position and highly accurate map information. In this case, the traveling position of the host vehicle M after the elapse of the prescribed time period can be represented as an arrival point P2 when the host vehicle M travels at a prescribed speed V determined by the following Eq. (1) for the prescribed time period.

V=v₀+Δv (1)

Here, v₀ denotes the present speed of the host vehicle M at the traveling point P1 and Δv denotes a speed that increases when an acceleration process due to acceleration allowed by the vehicle system 1 is continued for a prescribed time period (for example, 4 seconds in the example of FIG. 6). In the example of FIG. 6, because the point P2 is a point on the curved road, the mode determination unit 150 calculates a turning radius of the curved road. For example, the mode determination unit 150 calculates a value obtained by averaging turning radii of the road from the present point P1 to the point P2 as the turning radius in a present section.

Subsequently, the mode determination unit 150 estimates a dead reckoning limit speed of the curved road in front of the host vehicle M on the basis of the calculated turning radius of the curved road and corresponding information (step S105). In relation to the automated driving of the host vehicle M, the traveling speed of the host vehicle M may be set by the driver. In this case, the speed of the host vehicle M does not exceed a speed V_{D} set by the driver. Thus, when the above designated speed V_{D} is set, the mode determination unit 150 may compare the speed V calculated by Eq. (1) with the designated speed V_{D} and estimate a lower speed as the speed of the host vehicle M at the point P2.

Subsequently, the mode determination unit 150 determines whether or not an estimated speed at which the host vehicle M reaches the point P2 exceeds the dead reckoning limit speed estimated in step S105 (step S106). Here, when it is determined that the estimated speed when the host vehicle M reaches the point P2 exceeds the dead reckoning limit speed, the mode determination unit 150 changes the driving mode of the host vehicle M to a driving mode in which a severer task is imposed on the driver (step S107).

When the driving mode is changed, the driver's consent may be required according to the driving mode of a change destination. In this case, the driving mode can be changed when the driver responds to the request for changing the driving mode (for example, when the steering grip is detected) and control for casing the host vehicle M to be stopped safely is required when the driver does not respond to the request for changing the driving mode. For example, the example of FIG. 6 shows a case in which the driving mode is changed from mode B (steering grip: unnecessary) to mode C (steering grip: necessary). In this case, for example, when the mode determination unit 150 determines to change the driving mode at the point P1, the mode determination unit 150 requests the driver to grip the steering wheel to change the driving mode according to an information display process, a sound output process, or the like using the HMI 30 (TD: driving operation takeover request). The mode determination unit 150 changes the driving mode to mode C when the driver responds to the request for changing the driving mode. In this case, the mode determination unit 150 may return the driving mode to the original mode B at a timing when the risk of deviating from the lane disappears such as a timing when the host vehicle M has passed through a curved road. On the other hand, when the driver does not respond to the request for changing the driving mode, the mode determination unit 150 causes the host vehicle M to be safely stopped in accordance with the setting of minimal risk maneuver (MRM).

On the other hand, when it is determined that the position recognition has been performed normally in step S101, when it is determined that there is no curved road in a forward direction in step S103, or when it is determined that the estimated speed of the host vehicle M does not exceed the dead reckoning limit speed in step S106, the mode determination unit 150 ends a series of processing steps without changing the driving mode.

According to the automated driving control device 100 of the embodiment configured as described above, it is possible to perform appropriate control according to a road structure. Specifically, the automated driving control device 100 of the embodiment can limit unstable traveling of the host vehicle M by changing the present driving mode to a driving mode in which a severer task is imposed on the driver when dead reckoning has occurred in a situation where there is a curved road in a forward direction.

The embodiment described above can be represented as follows.

A vehicle control device including:

a storage device storing a program; and

a hardware processor,

wherein the hardware processor executes the program to:

recognize a surrounding situation of the vehicle;

control steering and acceleration/deceleration of the vehicle independently of an operation of a driver of the vehicle;

determine any one of a plurality of driving modes including a first driving mode and a second driving mode as a driving mode of the vehicle, the second driving mode being a driving mode in which a task imposed on the driver is milder than that in the first driving mode, some of the plurality of driving modes including at least the second driving mode being performed by controlling the steering and the acceleration/deceleration of the vehicle independently of the operation of the driver of the vehicle;

change the driving mode of the vehicle to a driving mode in which a task is severer when a task associated with the determined driving mode is not executed by the driver;

estimate a speed at which the vehicle travels on a road on the basis of curvature of the road in front of the vehicle when accuracy of recognition of the position of the vehicle is lowered; and

change the driving mode of the vehicle from the second driving mode to the first driving mode when the estimated speed exceeds a predetermined prescribed speed.

Although modes for carrying out the present invention have been described using embodiments, the present invention is not limited to the embodiments, and various modifications and substitutions can also be made without departing from the scope and spirit of the present invention.

What is claimed is:

1. A vehicle control device comprising:
a recognition unit configured to recognize a position and a surrounding situation of a vehicle;
a driving control unit configured to control steering and acceleration/deceleration of the vehicle independently of an operation of a driver of the vehicle; and
a mode determination unit configured to determine any one of a plurality of driving modes including a first driving mode and a second driving mode as a driving mode of the vehicle and change the driving mode of the vehicle to a driving mode in which a task is severer when a task associated with the determined driving mode is not executed by the driver, the second driving mode being a driving mode in which a task imposed on the driver is milder than that in the first driving mode, some of the plurality of driving modes including at least the second driving mode being controlled by the driving control unit,
wherein, when accuracy of recognition of the position of the vehicle is lowered, the mode determination unit estimates a speed at which the vehicle travels on a road on the basis of curvature of the road in front of the vehicle and changes the driving mode of the vehicle from the second driving mode to the first driving mode when the estimated speed exceeds a predetermined prescribed speed.

2. The vehicle control device according to claim 1,
wherein the second driving mode is a driving mode in which a task of gripping an operation element for receiving a steering operation is not imposed on the driver, and
wherein the first driving mode is a driving mode in which a driving operation by the driver is required in relation to at least one of the steering and the acceleration/deceleration of the vehicle.

3. The vehicle control device according to claim 1,
wherein the second driving mode is a driving mode in which a task of gripping an operation element for receiving a steering operation is not imposed on the driver, and
wherein the first driving mode is a driving mode in which at least the task of gripping the operation element for receiving the steering operation by the driver is imposed on the driver.

4. The vehicle control device according to claim 1, wherein the prescribed speed is a speed less than or equal to an upper limit of a speed at which the vehicle is able to travel in a traveling lane on the road having the curvature.

5. A vehicle control method comprising:
recognizing, by a computer mounted in a vehicle, a surrounding situation of the vehicle;
controlling, by the computer, steering and acceleration/deceleration of the vehicle independently of an operation of a driver of the vehicle;
determining, by the computer, any one of a plurality of driving modes including a first driving mode and a second driving mode as a driving mode of the vehicle, the second driving mode being a driving mode in which a task imposed on the driver is milder than that in the first driving mode, some of the plurality of driving modes including at least the second driving mode being performed by controlling the steering and the acceleration/deceleration of the vehicle independently of the operation of the driver of the vehicle;
changing, by the computer, the driving mode of the vehicle to a driving mode in which a task is severer when a task associated with the determined driving mode is not executed by the driver;
estimating, by the computer, a speed at which the vehicle travels on a road on the basis of curvature of the road in front of the vehicle when accuracy of recognition of the position of the vehicle is lowered; and
changing, by the computer, the driving mode of the vehicle from the second driving mode to the first driving mode when the estimated speed exceeds a predetermined prescribed speed.

6. A computer-readable non-transitory storage medium storing a program for causing a computer mounted in a vehicle to:
recognize a surrounding situation of the vehicle;
control steering and acceleration/deceleration of the vehicle independently of an operation of a driver of the vehicle;
determine any one of a plurality of driving modes including a first driving mode and a second driving mode as a driving mode of the vehicle, the second driving mode being a driving mode in which a task imposed on the driver is milder than that in the first driving mode, some of the plurality of driving modes including at least the second driving mode being performed by controlling the steering and the acceleration/deceleration of the vehicle independently of the operation of the driver of the vehicle;
change the driving mode of the vehicle to a driving mode in which a task is severer when a task associated with the determined driving mode is not executed by the driver;
estimate a speed at which the vehicle travels on a road on the basis of curvature of the road in front of the vehicle when accuracy of recognition of the position of the vehicle is lowered; and
change the driving mode of the vehicle from the second driving mode to the first driving mode when the estimated speed exceeds a predetermined prescribed speed.
